(19) United States
(12) Patent Application Publication
(10) Pub. No.: US 2003/0099854 A1
(43) Pub. Date: May 29, 2003

(54) Method for producing a clad metal product

(76) Inventors: David Smith, Skaneateles, NY (US); James P. Biernat, Skaneateles, NY (US); James Robinson, Auburn, NY (US); James Mach, Weedsport, NY (US); Arthur Carnicelli, Auburn, NY (US)

Correspondence Address: MOORE & VAN ALLEN, PLLC, 2200 W MAIN STREET, SUITE 800, DURHAM, NC, 27705, US

(21) Appl. No.: 09/994,103

(22) Filed: Nov. 26, 2001

(51) Int. Cl. B32B 15/00

(52) U.S. Cl. 428/615; 164/98

(57) ABSTRACT

A method is provided for producing a clad metal product having a core and a shell of different materials and suitable for use in forming processes. The method comprises the steps of providing a solid hollow shell member comprising a first metal, the shell open at one end and having an inner surface defining a cavity. A molten second metal from a source of molten metal is introduced into the cavity in sufficient quantity to substantially fill the cavity. The molten second metal is permitted to solidify thereby forming a workpiece having a core and a cladding shell of different metals which are sufficiently metallurgically bonded to one another at their interface. The final work product may be heated to rolling temperature and rolled to form a clad article of predetermined configuration.

### BACKGROUND

The present invention relates to a process for manufacturing a clad metal product and, more particularly, to a process for manufacturing a clad metal product for the fabrication of articles with coatings resistant to environmental conditions.

Steel materials are required to have sufficient mechanical strength for their uses. However, some uses expose the steel materials to environmental conditions which also require properties important for durability, such as corrosion resistance, heat resistance, and abrasive wear resistance. Most steel materials which are strong enough for their intended use may not be sufficiently resistant to environmental conditions to provide an acceptable service life. For example, steel has been widely used as reinforcement in concrete road construction. However, the life of plain carbon metal products is limited in this environment due to exposure to salt and other corrosive elements. The operating conditions in many industrial processes also require the use of corrosion resistant components. This problem can be remedied by using solid stainless steel, but the high cost associated with this solution is prohibitive.

Conventional practice has been to resort to coating, or cladding, a base metal with a protective metal or non-metallic layer, or mixtures thereof, for protecting the base metal. For example, corrosion resistant metal coatings, such as stainless steels and nickel-chromium alloys and other alloys, are applied to a base metal such as carbon steel. Utilizing a high tensile strength base metal and a corrosion-resistant outer layer yields the desired combination. Such clad metal articles provide economical advantages in that relatively cheap and strong base metals can be made satisfactory for use in severe environments by applying to the surface of the base metal a thin resistant coating. In general, the cladding material is more expensive than the base metal and this procedure enables production of a less expensive composite article which has an acceptable service life.

A number of conventional techniques exist for cladding a base metal with a different metal, with the goal being to produce a strong metallurgical bond between the layers of metal. Among these techniques is forged welding wherein two or more heated blanks are placed against one another and welded together by forging or hot rolling. Another method to produce clad metal product is through the use of powder metallurgy techniques wherein a metal tube is packed with metallic fines and shavings and then heated and rolled to the desired finished product shape. A third method is metallic deposition, such as spray welding, wherein a layer of cladding metal is added to the base metal surface prior to hot rolling. Metal cladding methods also include processes wherein metal may be cast about a metal core to form a composite ingot which is then worked down. The composite ingot can also be formed by casting metal for the outer layer into a mold and by draining unsolidified metal from the bottom of the mold after a certain thickness of solidified metal is molded. Then a molten metal, which will make up the core layer, is poured inside the molded metal shell.

None of the conventional methods have been used to produce high volumes of clad metal product due to relatively high manufacturing costs as a result of inefficiencies and complexity. Several of the methods include auxiliary operations and substantial scrap losses. Specifically, in the casting method, considerable segregation occurs in many cases during solidification of the molten metal which will become the core layer. Further, any interpositions adhere to the surfaces and cause poor adhesion between the core layer and the outer layer that result in a metallic product of poor mechanical quality.

For the foregoing reasons, there is a need for a method for producing clad metal products which is technically and economically more efficient than known methods. The new method should provide clad metal products including a base metal which is sufficiently metallurgically bonded to an environmentally-resistant outer layer. Ideally, the new metal product is a billet preform which may be utilized in conventional rolling or other working processes without layer separation.

### SUMMARY

According to the present invention, a method is provided for producing a clad metal product having a core and a shell of different materials and suitable for use in forming processes. The method comprises the steps of providing a solidified hollow shell member comprising a first metal, the shell open at one end and having an inner surface defining a cavity. A molten second metal from a source of molten metal is introduced into the cavity in sufficient quantity to substantially fill the cavity. The molten second metal is permitted to solidify thereby forming a workpiece having a core and a cladding shell of different metals which are sufficiently metallurgically bonded to one another at their interface. The second molten metal may be introduced into the cavity via any of the traditional casting methods including bottom pouring, vacuum filling or pressure filling. The final work product may be heated to rolling temperature and rolled to form a clad article of predetermined configuration.

These and other objects, features and advantages of the present invention will be apparent from the following description thereof and appended claims.

### DESCRIPTION

For a more complete understanding of the present invention, reference should now be had to the embodiments described below.

A method for producing a clad metal billet according to the present invention includes the steps of providing a solid metal shell, pouring a molten second metal into the shell and allowing the second metal to solidify in the shell. The resulting clad billet is thus produced in a single casting process. The clad billet has an inner core with the desired physical properties for mechanical strength and a surface cladding with the desired cosmetic or environmentally resistant properties. The billet may be used in subsequent processing steps, such as hot rolling, to form a clad metal article.

The solid metal shell comprises the cladding material. The cladding material may be selected from environmentally resistant materials such as corrosion resistant metals, stainless steel, or other ferrous metals such as mild steel, high tensile strength steels, very soft steels, high speed steels and abrasion resistant steels. Non-ferrous metals such as Ti, Nb, Mo, Zr, Al, Cr, and Cu can also be used. In certain applications, where the metal products are required to have heat resistance in addition to corrosion resistance, a heat resisting and corrosion resisting material can be employed. However, when expensive alloying elements like nickel or chromium are avoided substantial savings can be realized.

The core metal material may comprise ferrous metals, or an alloy containing a major proportion of ferrous metals, wherein the metal or alloy preferably has a composition to satisfy the structural demands of the service contemplated for the final metal product. An important characteristic of the core material is that it be readably bondable to the shell material under the temperature conditions employed in the pouring operation. In some applications, copper, bronze, aluminum and aluminum alloy cores may be cast in carbon or stainless steel shells. Combinations of non-ferrous metals may also be cast.

It is understood that the choice of shell and core metals depends on their material properties and qualities. The combination can be selected with consideration of the required strength, corrosion resistance, heat resistance, wear resistance, and the object of the use of the final clad products. In one embodiment, the cladding metal may be any stainless steel type, and preferably a 300 or 400 stainless steel. The core metal may be any commercially available carbon or alloy steel. For example, for steel bar used in reinforced concrete, the core metal is preferably carbon steel type A.I.S.I. 1050.

The shell is preferably tubular in form and has an open top portion and a closed bottom portion. The shell may have any desired cross-sectional configuration such as, for example, a circle, an ellipse, a square, a rectangle and the like. It is desirable from an economic and strength of final product standpoint for the clad layer to be thin. The thickness of the cladding of the final product is determined by the thickness of the initial shell and the proportion of the thickness to the transverse dimension of the core material. The shell thickness and core will be reduced proportionately during working, thereby facilitating determination of the starting shell thickness to provide a desired finished cladding thickness. Good results are obtainable when the wall thickness of the shell is large enough to provide a cladding which is at least about 5% of the cross-sectional area of the billet. When a billet is to be extruded or rolled, the wall thickness of the finished article should be at least about 0.030 inches thick after extrusion or rolling in order to prevent “tearing” of the shell during the extrusion or rolling process.

Before the shell is filled, a 6″ section of plain carbon steel is welded to the bottom end of the shell and the shell is securely positioned to receive the molten second metal. Scrap steel, or “chill scrap”, is added to the bottom of the shell in an amount sufficient to initiate solidification, usually about four inches. Any suitable technique for filling the shell with the molten metal can be used as long as the molten metal uniformly fills the container. This includes top pouring, bottom pouring, and vacuum filling. To facilitate the top or bottom pouring operation, means are provided for delivering molten metal to the shell. In the top pouring embodiment, the molten metal delivering means comprises a refractory funnel, or hot top liquid feed reservoir, welded on the open end of the shell for receiving and directing the molten metal into the shell. The funnel aids in filling the shell and provides a source of additional molten metal to counteract shrinkage during solidification. In the bottom pouring method, molten metal from a reservoir of molten metal is directed through a bottom pouring tube into the bottom of the shell for filling the shell from the bottom to the top thereby forcing molten metal upwards.

When pouring is completed, the area comprising the shell cavity is filled with the molten metal along the entire vertical length of the shell. The metal is allowed to cool and solidify. Cooling time is typically less than four hours.

Another method for producing a clad billet according to the present invention is vacuum casting the shell from a molten metal reservoir. A vacuum pump is attached to the outer free end of a tube leading to the reservoir. A vacuum is drawn in the reservoir and contained. The shell is attached to the vacuum reservoir and inserted into the molten metal reservoir. The vacuum is released and molten metal is drawn into the shell. The molten metal is allowed to cool and solidify. The vacuum casting process minimizes the risk of trapping air at the interface between the shell and the inner metal core.

Pressure casting of the core within the shell from a molten metal reservoir can also be used. A ceramic tube is provided and connected to the shell at one end. The other end of the ceramic tube is inserted into the molten metal reservoir. The reservoir is tightly covered and pressurized. The pressure forces molten metal up the ceramic tube filling the shell.

When the billet is complete, the result is a clad steel product comprising a shell of the first metal filled with a solidified core of the second metal. The inner surface of the shell is sufficiently metallurgically bonded to the outer surface of the core during solidification of the molten metal core. The strength of the billet is insured by the core member and at the same time environmental resistance is imparted by the cladding. When in addition to corrosion resistance the clad steel material is required to be, for example, heat resistant, cladding materials having a high heat resistance with corrosion resistance are employed thereby making the clad metal material useful in high temperature corrosive environments.

Once the billet preform has solidified, it may be subjected to known working processes such as hot or cold rolling, drawing or extruding to create a clad metal article such as a rod, tube, pipe, and the like. By causing the ratio of the cross-sectional areas of the original carbon steel core and stainless steel cladding to be constant at all cross-sections in the axial direction, the wall thickness of the clad steel product after preforming or rolling can be made uniform with high precision. It is also possible to interpose forging as an intermediate step or preceding the working step. The strong metallurgical bond which develops between the different metals enables working without breakage or separation of the cladding from the core whereby the thickness of the cladding of the product can be made as small as required and still provide ample heat resistance, wear resistance or corrosion resistance.

In order to give those skilled in the art a better understanding of the advantages of the invention, the following illustrative example for fabricating concrete reinforcement bars is given.

A 4″×6″ hollow Grade 304 stainless steel form measuring 12′ long was purchased from American Steel and Aluminum Corporation of Liverpool, N.Y. A molten metal of AISI 1050 was melted in an electric furnace and poured into the shell using a bottom pouring process. After the billet was cooled, it was subjected to forming. The billet was charged into a reheat furnace and soaked to a rolling temperature of approximately 2100° F. A 6″ inch piece of plain carbon steel was added to the end of the billet which enters the rolling mill. This unclad end of the billet was discharged to a rolling mill which aided in the “bite” of the billet in passing from one roll to another. The billet was hot rolled using conventional rolling techniques to length. Round bar produced by the rolling process had an outside diameter of about ½ inches and a cladding thickness of about 0.030 inches. The round bar were discharged onto a cooling bed. No cracks or tears were noted in the cladding and the cladding thickness was uniform from one end of the bar to the other. The bar was cut to lengths of about 20 feet.

Although the present invention has been shown and described in considerable detail with respect to only a few particular exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. For example, the method could be used be used to produce all manner and shape of clad metal articles depending on the parameters of the shell and the post-solidification processing. Accordingly, we intend to cover all such modifications, omissions, additions and equivalents as may be included within the spirit and scope of the invention as defined by the following claims.

We claim:

1. A method for producing a clad metal product having a core and a shell of different materials and suitable for use in forming processes, comprising the steps of:
providing a hollow shell member comprising a first metal, the shell open at one end and having an inner surface defining a cavity;
introducing a molten second metal from a source of molten metal into the cavity in sufficient quantity to substantially fill the cavity; and
permitting the molten second metal to solidify,
whereby, after solidification, a workpiece is formed having a core and a shell cladding of different metals which are sufficiently metallurgically bonded to one another at the interface.

2. A method for producing a clad metal product as recited in claim 1, wherein the second metal introduction step comprises delivering the second molten metal into the bottom of the cavity via a bottom pouring means positioned within the cavity so that the molten metal is delivered in a bottom pouring operation.

3. A method for producing a clad metal product as recited in claim 2, wherein the bottom pouring means comprises a refractory a bottom pouring tube connected to the mold and a funnel for containing the molten metal and directing the molten metal to the bottom pouring tube.

4. A method for producing a clad metal product as recited in claim 1, wherein the second metal introduction step comprises delivering the second molten metal into the cavity via a vacuum casting operation.

5. A method for producing a clad metal product as recited in claim 1, further comprising the steps of heating the work product to rolling temperature and rolling the work product to form a clad metal article of predetermined configuration.

6. A clad metal product produced by the process of claim 1.

7. A clad metal product produced by heating and rolling a workpiece according to claim 1.
